(19) United States
(12) Patent Application Publication
(10) Pub. No.: US 2026/0301547 A1
(43) Pub. Date: Oct. 1, 2026

(54) AUGMENTED REALITY CHECKOUT ASSISTANCE

(71) Applicant: Toshiba Global Commerce Solutions, Inc., Durham, NC (US)

(72) Inventors: Kam Yee, Apex, NC (US); Wendy Darby, Raleigh, NC (US); Thomas Best, JR., Raleigh, NC (US); Parag Chikmath, Raleigh, NC (US); Edgar Bernal, Cary, NC (US); Mahmoud Marhaoui, Holly Springs, NC (US); Jim Morgan, Mahanoy City, PA (US); Kristen Mark, Raleigh, NC (US); Dana Edwards, Fuquay-Varina, NC (US); Paul Harmon, Durham, NC (US); Paul Scrutton, Durham, NC (US); Robert Hutchens-LaPrelle, Chapel Hill, NC (US)

(73) Assignee: Toshiba Global Commerce Solutions, Inc., Durham, NC (US)

(21) Appl. No.: 19/095,592

(22) Filed: Mar. 31, 2025

(51) Int. Cl. G07G 1/00; G06Q 20/20; G06T 7/70; G06T 11/00; G06V 20/20; G06V 20/40

(52) U.S. Cl. CPC G07G 1/0009; G06Q 20/202; G06Q 20/208; G06T 7/70; G06T 11/00; G06V 20/20; G06V 20/41; G06T 2207/10016

(57) ABSTRACT

Methods and systems of augmented reality (AR) checkout assistance are performed. In one exemplary embodiment, a method is performed by a controller device of a POS system that is operationally coupled to an AR device. The AR device is configured to be worn and includes an optical sensor with a field of view that corresponds to a field of view of the AR device and a display device configured to overlay a display of an augmented sequential image that can be viewed in the field of view of the AR device. The method includes sending, by the controller device, to the AR device, an indication that includes data associated with an augmented sequential image that includes at least one of a set of visual indicators that indicates at least one of a set of checkout statuses of a target object disposed about the POS system.

### BACKGROUND

Augmented reality (AR) devices overlay digital content onto aspects of a wearer's real world environment to enhance the wearer's perception of his or her surroundings. AR devices typically are worn by a wearer and include hardware such as a camera and display device, along with software that processes and integrates virtual elements into a sequential image for display by the display device to the wearer. The Background section of this document is provided to place embodiments of the present disclosure in technological and operational context, to assist those of skill in the art in understanding their scope and utility. Unless explicitly identified as such, no statement herein is admitted to be prior art merely by its inclusion in the Background section.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1 illustrates one embodiment of a system providing AR checkout assistance via an AR device in accordance with various aspects as described herein.

FIG. 2A illustrates one embodiment of a controller device operable to control an AR device in accordance with various aspects as described herein. FIG. 2B illustrates one embodiment of an AR device in accordance with various aspects as described herein.

FIG. 3A illustrates another embodiment of a controller device operable to control an AR device in accordance with various aspects as described herein. FIG. 3B illustrates another embodiment of an AR device in accordance with various aspects as described herein.

FIG. 4A illustrates one embodiment of a method performed by a controller device of controlling an AR device in accordance with various aspects as described herein. FIG. 4B illustrates one embodiment of a method performed by an AR device of providing AR checkout assistance in accordance with various aspects as described herein.

FIG. 5 illustrates another embodiment of a controller device or an AR device in accordance with various aspects as described herein.

### DETAILED DESCRIPTION

For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details.

One of the factors contributing to a frustrating checkout experience is the time spent waiting in line before receiving service. Additionally, the efficiency of the checkout attendant can further impact the experience. Checkout attendants typically perform tasks manually, processing items one at a time through actions such as lookup, scanning, and weighing. This disclosure introduces the application of AR goggles in the retail sector to assist checkout attendants, enhancing efficiency and expediting the checkout process for a more seamless experience. The AR goggles can continuously capture the attendant's field of view, focusing on the checkout belt in grocery stores or the checkout counter in other retail settings. Connected to the point-of-sale (POS) system, the AR goggles can utilize existing visual recognition technology to automatically identify and ring up recognizable items. Additionally, the AR display can overlay visual indicators (e.g., icons or bubble images) to assist the attendant. Those items successfully processed can appear with a green checkmark, those requiring weighing can appear with a scale icon, and unrecognized or manually required items can be flagged with an exclamation mark. By automating item recognition and highlighting only those items requiring manual attention, the AR goggles can streamline the checkout process, enabling checkout attendants to efficiently pass processed items to the bagging area or a bagging attendant while focusing on necessary manual tasks.

The present disclosure also describes, among other things, a controller device of a POS system (e.g., assisted checkout station) having information (e.g., price, product type, stock) associated with a set of retail items (e.g., produce, canned goods, dairy products, frozen foods, beverages, bakery items, meat, seafood, snacks, household products, personal care products, general merchandise products) that is operationally coupled to an AR device configured to be worn by a checkout attendant at an assisted checkout station in a POS environment (e.g., retail store). The AR device includes a processing circuitry that is operationally coupled to an optical sensor (e.g., camera) and a display device (e.g., optical see-through device, video see-through device, projection-based display, micro-display AR screen). The optical sensor is operable to capture a sequential image and has a field of view that corresponds to a field of view of a wearer of the AR device while the wearer is wearing the AR device. The display device is configured to overlay digital content onto the real world as viewed by the wearer of the AR device.

In one example, the display device can include a transparent display that can include an optical waveguide (e.g., glass or polymer lens or goggles) and a projector or micro-display that projects light onto the optical waveguide using optical techniques (e.g., holographic imagery, diffraction gratings, total internal reflection) that enables the wearer to see their physical surroundings directly while embedding augmented sequential images in the wearer's direct sight. In another example, the display device can include a heads-up display that includes a lens (e.g., glasses, visor) and a projector. Further, the display device can be operable to project augmented sequential images directly on the lens so that the wearer can simultaneously see both the heads-up display and the environment. In yet another example, the display device can include a video pass-through display, with a display screen in the wearer's field of view. An optical sensor of the AR device captures the environment that corresponds to the field of view of the AR device, with sequential imagery captured by the optical sensor being augmented by virtual content and overlaid on the captured imagery for display on the display screen. For a video pass-through display, the field of view of the wearer at a particular moment in time is the field of view that the wearer would have if the wearer was not wearing the AR device at that time. The AR device can also be operationally coupled to other sensor devices including motion sensors (e.g., gyroscopes, accelerometers). A motion sensor can be used by the AR device to track a wearer's head movement and position so that the virtual elements displayed by the display device of the AR device stay aligned with the corresponding real-world objects in the wearer's field of view.

In one embodiment, the controller device can receive from the processing circuitry of the AR device an indication that includes data that represents a sequential image captured by the optical sensor of the AR device. The controller device can determine that a target object is detected in the field of view of the optical sensor (such as in a shopping cart, basket, checkout platform, checkout conveyor, or the like), identify that the target object corresponds to a retail item of the set of retail items, determine a retail item indicator of a set of retail item indicators (e.g., barcode, QR code, RFID, NFC, PLU) associated with the target object based on the identified retail item and stored purchasing information, and send to the AR device an indication that includes data associated with an augmented sequential image that includes a visual indicator that indicates the determined retail item indicator to be displayed proximate a position of the target object in the field of view of the optical sensor so that the AR device is enabled to display on the display of the display device the visual indicator proximate the position of the target object while viewed by the wearer of the AR device.

In this disclosure, an exemplary embodiment includes a controller device operationally coupled to an AR device with the controller device being a part of a POS system having information associated with a set of retail items. The AR device is configured to be worn, and it has a processing circuitry operationally coupled to an optical sensor having a field of view that corresponds to a field of view of a wearer of the AR device. The AR device is operable to capture a sequential image through the optical sensor. The processing circuitry of the AR device is further operationally coupled to a display device configured to be viewed in the field of view of the wearer while the AR device is worn and operable to display an augmented sequential image. The exemplary embodiment includes the controller device sending to the AR device an indication that includes data associated with an augmented sequential image that includes a visual indicator of a set of visual indicators that indicates a determined retail item indicator of a set of retail item indicators that is associated with a target object disposed about the POS system, with the visual indicator to be displayed proximate a position of the target object in the field of view of the optical sensor so that the AR device is enabled to display on the display device the visual indicator proximate the position of the target object while viewed by the wearer through the AR device.

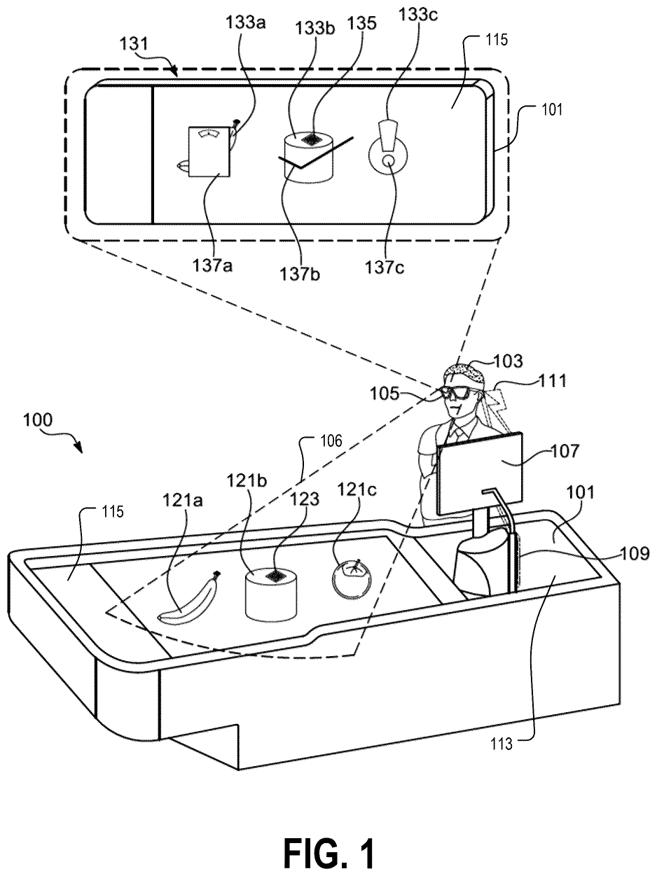

FIG. 1 illustrates one embodiment of a POS environment 100 having a POS checkout station 101 that includes a bagging area 113 configured for bagging retail items and a conveyor belt 115 configured to move retail items towards a sales attendant 103 who is wearing an AR device 105 and has a field of view 106 towards a portion of the station 101. The AR device 105 includes an optical sensor with a field of view that corresponds to the field of view 106 of the AR device 105 and a display device configured to overlay a display of an image while the attendant 103 is viewing the environment 100 through the AR device 105. The station 101 further includes a controller device 109 operationally coupled to the AR device 105 via a wired connection (e.g., serial, USB, HDMI) or a wireless connection (e.g., Bluetooth, Wi-Fi). The controller device 108 can also include a display monitor 107 configured to display information such as information associated with a current POS transaction.

As illustrated in FIG. 1, the field of view 106 of the attendant 103 can include several objects 121a-c that correspond to retail items such as a banana 121a, a can 121b, and an orange 121c are disposed about the station 101 such as on the conveyor 115. The controller device 109 can generate an augmented image 131 that includes a visual identifier 137a-c of a set of visual identifiers (e.g., green checkmark, scale, exclamation point, red ‘X’) that represents a corresponding checkout status of a set of POS checkout statutes (e.g., scanned, weight measurement required, unscanned, not a retail item) of the corresponding object 121a-c. The AR device 105 can be configured to overlay the augmented image 131 having the visual identifiers 137a-c in the field of view 106 of the AR device 105 so that the attendant 103 can view the visual identifiers 137a-c overlayed on the target object 121a-c.

In operation, the controller device 109 can receive, from the AR device 105, data that represents a sequential image captured by the optical sensor of the AR device 105 while the field of view of the optical sensor is directed towards the objects 121a-c disposed about the station 101. In response, the controller device 109 can obtain the sequential image data that includes the set of objects 121a-c disposed about the checkout station 101 based on the indication. The controller device 109 can detect, based on the sequential image data, the set of objects 121a-c and can select one of the set of detected objects 121a-c as a target object 121a-c. The controller device 109 can classify or identify the target object 121a-c based on the sequential image data and the set of retail items to obtain an identified retail item. In one example, the controller device 109 can detect, based on the sequential image data, one of a set of retail item indicators 123 (e.g., barcode, QR code, RFID, NFC, PLU) on a target object 121b and can determine one of the set of retail items corresponding to the target object 121b based on information associated with the detected retail item indicator 123. In another example, the controller device 109 can send, to an artificial intelligence (AI) circuitry, an indication that includes a request to predict, based on the sequential image data, a retail item corresponding to the target object 121a-c, with the AI circuitry being trained on information associated with a set of retail items. Further, the controller device 109 can receive, from the AI circuitry an indication that includes at least one of the set of retail items and a corresponding confidence level. The controller device 109 can then select one of the at least one of the set of retail items based on the corresponding confidence levels to obtain the identified retail item 121a-c. The controller device 109 can obtain a price of the identified retail item 121a-c based on the information associated with the set of retail items and can then add the purchase of that item to the current transaction. Further, the controller device 109 can determine at least one of a set of checkout statuses to associate with the identified retail item 121a-c to obtain a checkout status of the identified retail item 121a-c. The controller device 109 can determine a retail item indicator 137a-c of a set of retail item indicators associated with the target object 121a-c based on the checkout status of the identified retail item 121a-c. In addition, the controller device 109 can determine a position of the target object 121a-c in the field of view of the AR device 105 based on the sequential image data. The controller device 109 can also obtain at least one of a set of visual indicators that corresponds to the obtain a visual indicator 137a-c that corresponds to the determined retail item indicator. The controller device can then map the visual indicator 137a-c proximate the position of the target object 121a-c to obtain augmented sequential image data. The controller device then sends to the AR device 105 an indication that includes the augmented sequential image data so that the AR device 105 is enabled to display on the display of the display device the visual indicator 137a-c proximate the position of the target object 121a-c while viewed by the sales clerk 103 through the AR device 105 so that the sales clerk 103 is enabled to view the augmented sequential image 131.

In another exemplary embodiment, the AR device 105 can perform any or all of the functions described herein. For instance, the AR device 105 can receive from the optical sensor an indication that includes sequential image data, obtain the sequential image data, detect the set of objects 121a-c in the sequential image data, select the target object 121a-c, and send to the controller device an indication that includes a request to classify or identify the target object 121a-c. Further, the AR device 105 can receive, from the controller device 109, an indication that includes the visual indicator 137a-c that corresponds to the target object 121a-c. The AR device 105 can then determine a position of the target object 121a-c in the field of view of the AR device 105 based on the sequential image data and can overlay the visual indicator 137a-c proximate the position of the target object 121a-c to obtain data that represents an augmented sequential image having the visual indicator 137a-c. In addition, the AR device 105 can overlay the display of the visual indicator proximate the position of the target object 121a-c while viewed through the AR device 105 so that the attendant 103 can view the visual indicators 137a-c proximate a position of the target object 121a-c while the target object 121a-c is viewable in the field of view of the AR device 105.

In another exemplary embodiment, the AR device 105 can also receive indications from a motion sensor (e.g. accelerometer, gyroscope) operationally coupled to the AR device 105 to track the head movements and position of the attendant 103 so that virtual elements 137a-c displayed by the display device of the AR device 105 stay aligned with detected objects 121a-c in the field of view of the attendant 103.

In another embodiment, the AR device 105 can receive an indication from the controller device updating a retail item indicator 137a-c associated with the target object 121a-c, and the AR device 105 is thereafter operable to obtain a visual indicator 137a-c corresponding to the updated retail item indicator. The AR device can display the updated visual indicator 137a-c proximate the position of the target object 121 a-c.

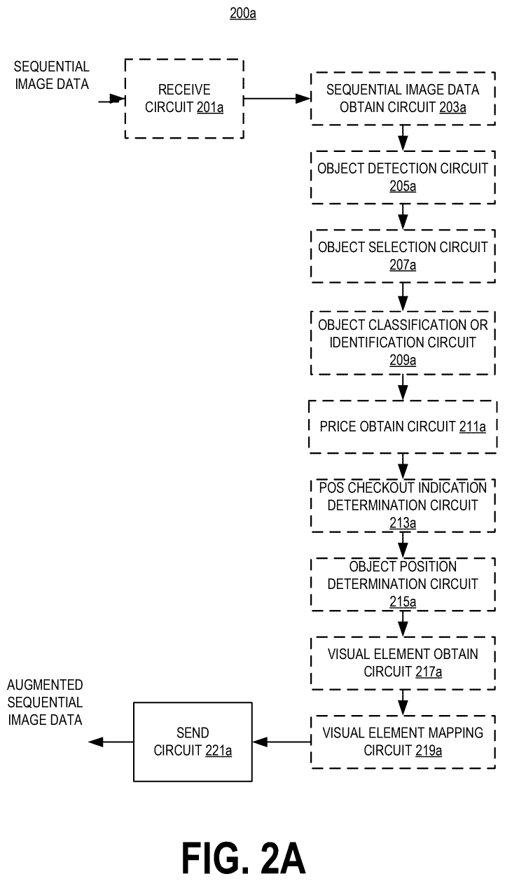

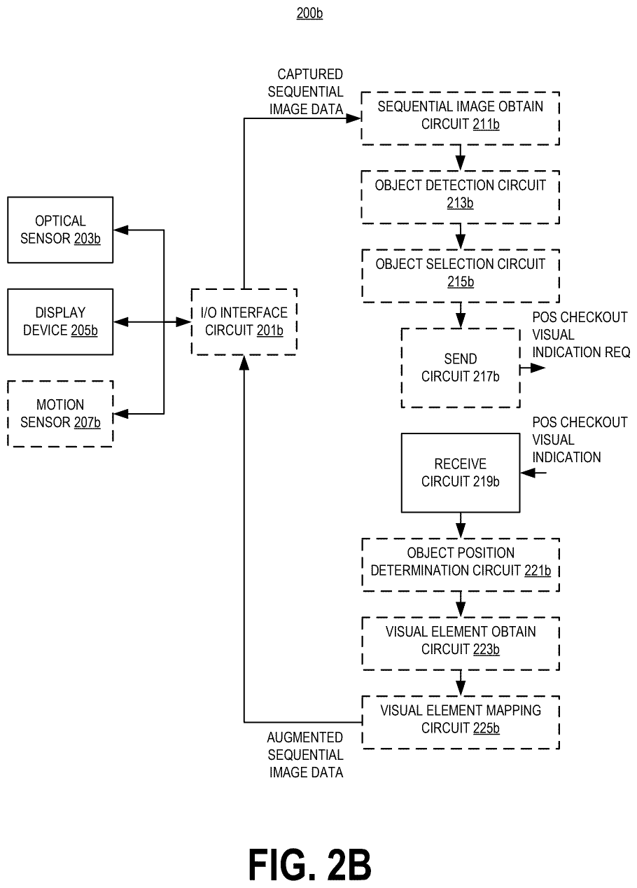

FIG. 2A illustrates one embodiment of a controller device 200a in accordance with various aspect as described herein. In FIG. 2A, the controller device 200a implements various functional means, units, modules (e.g. via a processing circuitry, software code, or the like), or circuits. In one embodiment, these functional means, units, modules or circuits (e.g. for implementing the method(s) described herein) may include for instance an input/output circuitry that is operable to transfer information to or from the functional means, units, modules, or circuits of the controller device 200a. The functional means, units, modules or circuits can further include a receive circuitry 201a that can receive an indication that includes sequential image data from an AR device that is operationally coupled to the controller device 200a. The functional means, units, modules or circuits of the controller device 200a can further include a sequential image data obtain circuitry 203a operable to obtain the received sequential image data; an object detection circuitry 205a operable to detect objects in the sequential image data; an object selection circuitry 207a operable to select an object from a set of detected objects to obtain a selected object; an object classification or identification circuitry 209a operable to classify or identify a selected object as a retail item of a set of retail items that corresponds to the selected object; a price obtain circuitry 211a operable to obtain a price associated with an identified retail item; a retail item indicator determination circuitry 213a operable to determine a retail item indicator associated with a selected object; an object position determination circuitry 215a operable to determine a position of a selected object in the field of view of the optical sensor based on captured sequential image data; a visual indicator obtain circuitry 215a operable to obtain a visual indicator that corresponds to a determined retail item indicator; a visual indicator mapping circuitry 219a operable to map the visual indicator proximate a position of the target object; and a send circuitry 221 operable to send to the AR device an indication that includes augmented sequential image data associated with a mapping of a visual indicator to a position of a selected object as displayed in a sequential image to enable the AR device to display the visual indicator proximate the position of the selected object.

FIG. 2B illustrates one embodiment of an AR device 200b in accordance with various aspect as described herein. In FIG. 2B, the AR device 200b implements various functional means, units, modules (e.g. via a processing circuitry, software code or the like), or circuits. In one embodiment, these functional means, units, modules or circuits (e.g. for implementing the method(s) described herein) may include for instance an input/output circuitry 201b that is operable to transfer information to or from the functional means, units, modules or circuits of the AR device 200b. The input/output interface 201b can be further operable to transfer information to or from the functional means, units, modules, or circuits and any of the following devices: an optical sensor 203b, a display device 205b, and a motion sensor 207b (e.g. accelerometer, gyroscope). These functional means, units, modules or circuits can include a sequential image obtain circuitry 211b operable to obtain sequential image data captured by the optical sensor 203b; an object detection circuitry 213b operable to detect an object in the sequential image data; an object detection circuitry 215b operable to select an object from a set of one or more detected objects; a send circuitry 217b operable to send information including a request to obtain a retail item indicator of a set of retail item indicators for the selected object; a receive circuitry 219b operable to receive information, including an indication that includes a retail item indicator for the selected object; an object position determination circuitry 221b operable to determine a position of the selected object in the field of view of the optical sensor based on captured sequential image data; a visual indicator obtain circuitry 223b operable to obtain a visual indicator corresponding to a received retail item indicator; and a visual indicator mapping circuitry 225b operable to map a visual indicator proximate a position of the selected object to enable the AR device 200b to display the visual indicator proximate the position of the selected object.

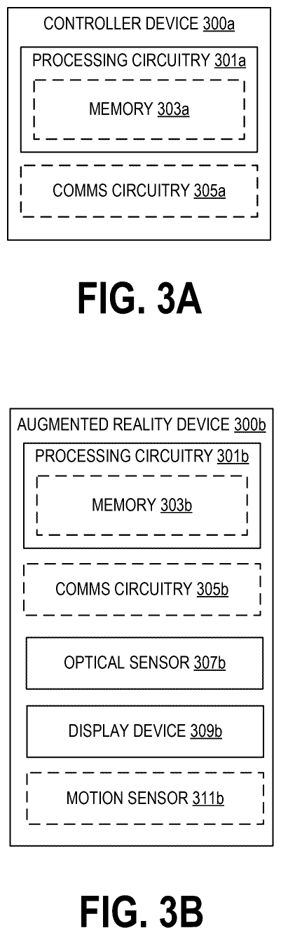

FIG. 3A illustrates another embodiment of a controller device 300a in accordance with various aspect as described herein. In FIG. 3A, the controller device 300a can include processing circuitry 301a operationally coupled to a memory 303a, a network communications circuitry 305a, or any combination thereof. The network communications circuitry 305a can be configured to transmit and/or receive information to and/or from one or more network node devices via any communication technology. The processing circuitry 301a can be configured to perform processing described herein, such as by executing instructions stored in the memory 303a. The processing circuitry 301a in this regard may implement certain functional means, units or modules.

FIG. 3B illustrates another embodiment of an AR device 300b in accordance with various aspect as described herein. In FIG. 3B, the AR device 300b can include processing circuitry 301b operationally coupled to one or more of the following: a memory 303b, a network communications circuitry 305b, an optical sensor 307b, a display device 309b, a motion sensor 311b (e.g. accelerometer, gyroscope), or any combination thereof. The network communications circuitry 305b can be configured to transmit and/or receive information to and/or from one or more network node devices via any communication technology. The processing circuitry 301b can be configured to perform processing described herein, such as by executing instructions stored in the memory 303b. The processing circuitry 301b in this regard may implement certain functional means, units or modules. The optical sensor 307b can be operable to capture a sequential image, the display device 309b can be operable to display information, and the motion sensor 311b can be operable to measure motion.

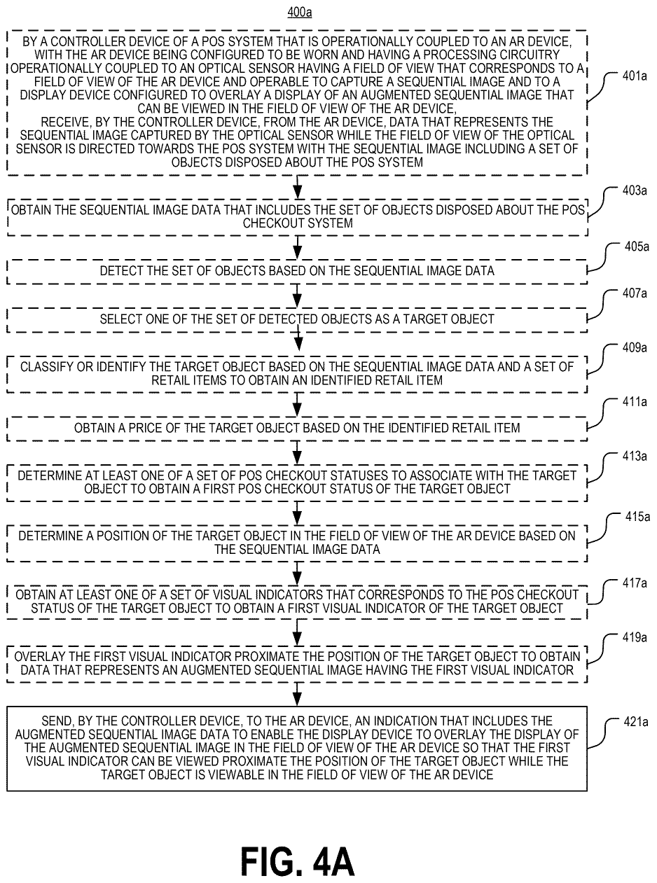

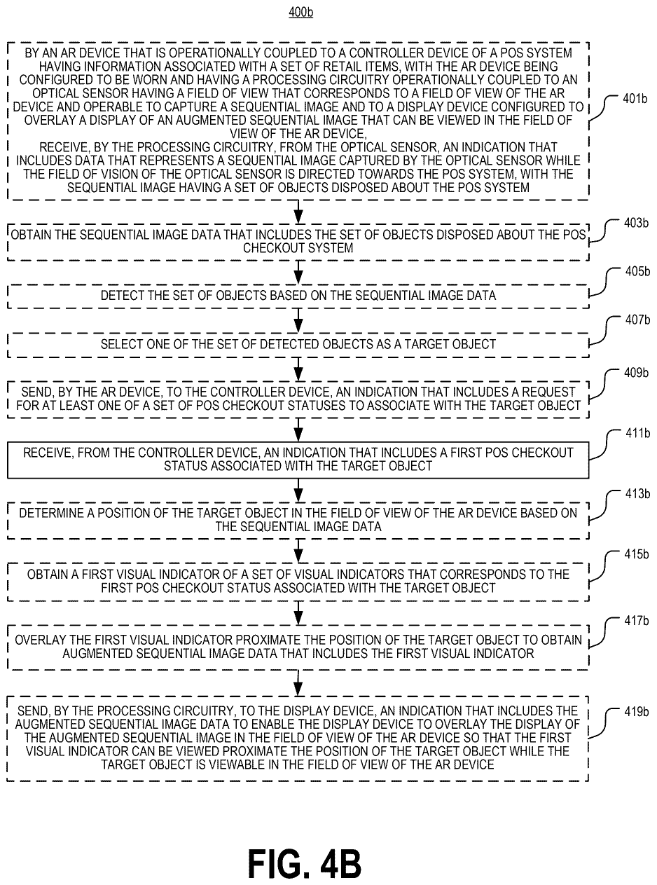

FIG. 4A illustrates one embodiment of a method 400a performed by a controller device in accordance with various aspect as described herein. In FIG. 4A, the method 400a, may start, for instance, at block 401a, where the method 400a can include receiving from an AR device data that represents a sequential image captured by an optical sensor of the AR device while the field of view of the optical sensor is directed towards a POS checkout system with the sequential image including a set of objects disposed on the POS checkout system. At block 403a, the method 400a may include obtaining the sequential image data that includes the set of objects disposed on the POS checkout system. At block 405a, the method 400a may include detecting the set of objects based on the sequential image data. At block 407a, the method 400a may include selecting one of the set of detected objects as a target object. At block 409a, the method 400a may include classifying or identifying the target object based on the sequential image data and a set of retail items to obtain an identified retail item. This step could be accomplished by a detection in the sequential image data of a QR code on a target object and determining a retail item corresponding to the target object based on identification information contained in the QR code to obtain the identified retail item. This step could also be accomplished by sending by the processing circuitry of the controller device to an artificial intelligence (AI) circuitry an indication that includes a request to predict, based on the sequential image data, a retail item corresponding to the target object, wherein the AI circuitry is trained on information associated with a set of retail items, and then receiving from the AI circuitry an indication that includes at least one of the set of retail items and a corresponding confidence level; the controller device can then select one of the at least one of the set of retail items based on the corresponding confidence level to obtain the identified retail item. At block 411a, the method 400a may include obtaining a price of the target object based on the identified retail item. This step may be accomplished through querying information on the identified retail item contained in the POS system. At block 413a, the method 400a may include determining a retail item indicator of a set of retail item indicators associated with the target object. This step may be accomplished through querying information on the identified retail item contained in the POS system. For example, information on the identified retail item may indicate that the identified retail item has a weight dependent price, so if there is not a weight stored in the POS system associated with the target object, then the retail item indicator can indicate that a weight measurement is required to obtain a price of the target object. If the identified retail item does not have a weight dependent price and its price is stored in the POS system, then the retail item indicator can indicate that the price of the target object has been obtained. If neither a price nor a weight dependent price is found for the identified retail item (or an identified retail item was not found) the retail item indicator can indicate that manual processing is required. At block 415a, the method 400a may include determining a position of the target object in the field of view of the optical sensor based on the sequential image data. At block 417a, the method 400a may include obtaining a visual indicator that indicates that the price of the identified retail item has been obtained. The visual indicator corresponding to the checkout status indication may be located in a memory of the controller device, the AR device or in a database of the POS system. At block 419a, the method 400a may include mapping the visual indicator proximate the position of the target object as displayed in the sequential image to obtain augmented sequential image data. At block 421a, the method 400a includes sending, by a processing circuitry of the controller device, to the AR device an indication that includes the augmented sequential image data so that the AR device is enabled to display on the display device the visual indicator proximate the position of the target object while viewed by the wearer through the AR device.

FIG. 4B illustrates one embodiment of a method 400b performed by an AR device in accordance with various aspect as described herein. In FIG. 4B, the method 400b, may start, for instance, at block 401b, wherein the method 400b can include receiving, by the processing circuitry of the AR device, from the optical sense, an indication that includes data that represents a sequential image captured by the optical sensor while the field of view of the optical sensor is directed towards a POS checkout system with the sequential image including a set of objects disposed on the POS checkout system. At block 403b, the method 400b may include obtaining the sequential image data that includes the set of objects disposed on the POS checkout system. At block 405b, the method 400b may include detecting the set of objects based on the sequential image data. At block 407b, the method 400b may include selecting one of the set of detected objects as a target object. At block 409b, the method 400b may including sending to the controller device an indication that includes a request for a retail item indicator of a set of retail item indicators that corresponds to the target object. This indication may further include the captured sequential image data. At block 411b, the method 400b includes receiving, from the controller device, an indication that includes the retail item indicator corresponding to the target object. At block 413b, the method 400b may include determining a position of the target object in the sequential image data based on the sequential image and the target object. At block 415b, the method 400b may include obtaining a visual indicator that indicates the received retail item indicator. The visual indicator corresponding to the checkout status indication may be located in a memory of the AR device or in a database of the POS system. At block 417b, the method 400b may include mapping the visual indicator proximate the position of the target object as displayed in the sequential image to obtain augmented sequential image data. At block 419b, the method 400b may include sending, by the processing circuitry of the AR device, to the display device an indication that includes the augmented sequential image data so that the display device is enabled to display the visual indicator proximate the position of the target object while viewed by the wearer through the AR device.

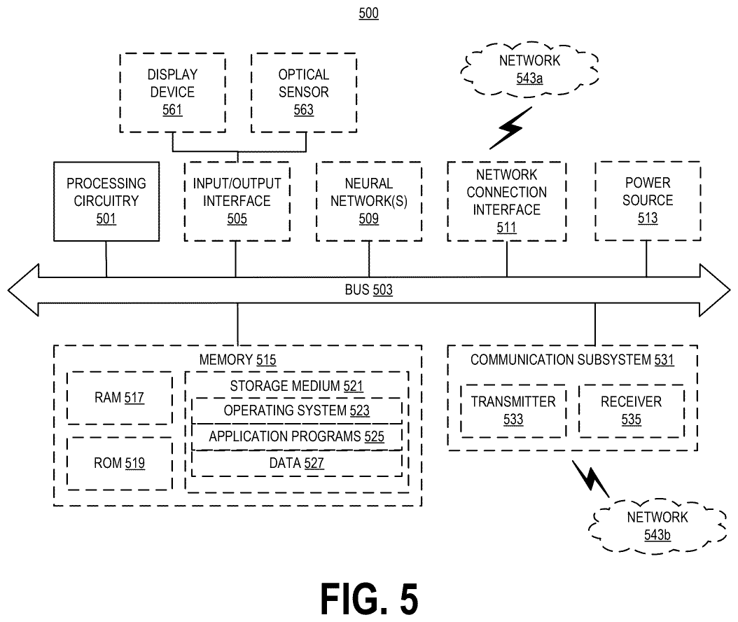

FIG. 5 illustrates another embodiment of a controller device or an AR device 500 in accordance with various aspects as described herein. In FIG. 5, device 500 includes processing circuitry 501 that is operatively coupled to input/output interface 505, artificial intelligence (AI) circuitry 509, network connection interface 511, memory 515 including random access memory (RAM) 517, read-only memory (ROM) 519, and non-volatile memory 521 or the like, communication subsystem 531, power source 513, and/or any other component, or any combination thereof.

The input/output interface 505 may be configured to provide a communication interface to an input device, output device, or input and output device. The device 500 may be configured to use an output device via input/output interface 505. An output device may use the same type of interface port as an input device. For example, a USB port may be used to provide input to and output from the device 500. The output device may be a speaker, a sound card, a video card, a display device 561, a presence sensitive display device, a monitor, a printer, an actuator, an emitter, a smartcard, another output device, or any combination thereof. The device 500 may be configured to use an input device via input/output interface 505 to allow a wearer to capture information into the device 500. The input device may include a weight sensor (e.g., electronic weight scale), an optical sensor 563 (e.g., camera), a presence sensitive display device, another input device, a scanner (e.g., barcode scanner) an accelerometer, a microphone, a sensor, a mouse, a trackball, a directional pad, a trackpad, a scroll wheel, a smartcard, and the like. The presence-sensitive display device may include a capacitive or resistive touch sensor to sense input from a wearer. A sensor may be, for instance, an accelerometer, a gyroscope, a tilt sensor, a force sensor, a magnetometer, an optical or image sensor, an infrared sensor, a proximity sensor, another like sensor, or any combination thereof.

In FIG. 5, non-volatile memory 521 may include operating system 523, application program 525, data 527, the like, or any combination thereof. In other embodiments, non-volatile memory 521 may include other similar types of information. Certain devices may utilize all of the components shown in FIG. 5, or only a subset of the components. The level of integration between the components may vary from one device to another device. Further, certain devices may contain multiple instances of a component, such as multiple processors, memories, neural networks, network connection interfaces, transceivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In FIG. 5, a neural network 509 may be configured to learn to perform tasks by considering examples such as performing object detection of certain objects in an image. In one example, a first AI circuitry of a neural network 509 is configured to perform object detection or identification, in an image, of subjects, faces of subjects, vehicles, license plates on vehicles, or the like. Further, a second AI circuitry of a neural network 509 is configured to perform detection of an activity of a subject. In FIG. 5, the network connection interface 511 may be configured to provide a communication interface to network 543a. The network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. The network connection interface 511 may be configured to include a receiver and a transmitter interface used to communicate with one or more other devices over a communication network according to one or more communication protocols, such as Ethernet, TCP/IP, SONET, ATM, or the like. The network connection interface 511 may implement receiver and transmitter functionality appropriate to the communication network links (e.g., optical, electrical, and the like). The transmitter and receiver functions may share circuitry components, software or firmware, or alternatively may be implemented separately.

The RAM 517 may be configured to interface via a bus 503 to the processing circuitry 501 to provide storage or caching of data or computer instructions during the execution of software programs such as the operating system, application programs, and device drivers. The ROM 519 may be configured to provide computer instructions or data to processing circuitry 501. For example, the ROM 519 may be configured to store invariant low-level system code or data for basic system functions such as basic input and output (I/O), startup, or reception of keystrokes from a keyboard that are stored in a non-volatile memory. The non-volatile memory 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, the non-volatile memory 521 may be configured to include an operating system 523, an application program 525 such as web browser, web application, wearer interface, browser data manager as described herein, a widget or gadget engine, or another application, and a data file 527. The non-volatile memory 521 may store, for use by the device 500, any of a variety of various operating systems or combinations of operating systems.

The non-volatile memory 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable wearer identity (SIM/RUIM) module, other memory, or any combination thereof. The non-volatile memory 521 may allow the device 500 to access computer-executable instructions, application programs or the like, stored on transitory or non-transitory memory media, to off-load data, or to upload data. An article of manufacture, such as one utilizing a communication system may be tangibly embodied in the non-volatile memory 521, which may comprise a device readable medium.

The processing circuitry 501 may be configured to communicate with network 543b using the communication subsystem 531. The network 543a and the network 543b may be the same network or networks or different network or networks. The communication subsystem 531 may be configured to include one or more transceivers used to communicate with the network 543b. For example, the communication subsystem 531 may be configured to include one or more transceivers used to communicate with one or more remote transceivers of another device capable of wireless communication according to one or more communication protocols, such as IEEE 802.11, CDMA, WCDMA, GSM, LTE, UTRAN, WiMax, or the like. Each transceiver may include a transmitter 533 and/or receiver 535 to implement transmitter or receiver functionality, respectively, appropriate to the RAN links (e.g., frequency allocations and the like). Further, transmitter 533 and receiver 535 of each transceiver may share circuitry components, software, or firmware, or alternatively may be implemented separately.

In FIG. 5, the communication functions of the communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 531 may include cellular communication, Wi-Fi communication, Bluetooth communication, and GPS communication. The network 543b may encompass wired and/or wireless networks such as a local-area network (LAN), a wide-area network (WAN), a computer network, a wireless network, a telecommunications network, another like network or any combination thereof. For example, the network 543b may be a cellular network, a Wi-Fi network, and/or a near-field network. The power source 513 may be configured to provide alternating current (AC) or direct current (DC) power to components of the device 500.

The features, benefits and/or functions described herein may be implemented in one of the components of the device 500 or partitioned across multiple components of the device 500. Further, the features, benefits, and/or functions described herein may be implemented in any combination of hardware, software, or firmware. In one example, communication subsystem 531 may be configured to include any of the components described herein. Further, the processing circuitry 501 may be configured to communicate with any of such components over the bus 503. In another example, any of such components may be represented by program instructions stored in memory that when executed by the processing circuitry 501 perform the corresponding functions described herein. In another example, the functionality of any of such components may be partitioned between the processing circuitry 501 and the communication subsystem 531. In another example, the non-computationally intensive functions of any of such components may be implemented in software or firmware and the computationally intensive functions may be implemented in hardware.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts for illustrative purposes, but the embodiments are similarly applicable in other contexts not explicitly described.

In one exemplary embodiment, a method is performed by a controller device of POS system that is operationally coupled to an AR device. The AR device is configured to be worn and has an optical sensor with a field of view that corresponds to a field of view of the AR device and operable to capture a sequential image. The AR device also has a display device configured to overlay a display of an augmented sequential image in the field of view of the AR device. The method includes sending, by the controller device, to the AR device, an indication that includes data associated with an augmented sequential image that includes at least one of a set of visual indicators that indicates at least one of a set of checkout statuses of a target object disposed about the POS system, with the display device being operable to overlay the display of the augmented sequential image in the field of view of the AR device so that the at least one visual indicator of the set of visual indicators can be viewed proximate a position of the target object is viewable in the field of view of the AR device.

In another exemplary embodiment, the method further includes each of the following: receiving, by the controller device, from the AR device, data that represents the sequential image captured by the optical sensor while the field of view of the optical sensor is directed towards the POS system with the sequential image having a set of objects disposed about the POS system; detecting the set of objects disposed about the POS system based on the sequential image; and selecting one of the set of objects to obtain the target object.

In another exemplary embodiment, the method further includes classifying or identifying the target object based on the sequential image data and a set of retail items to obtain an identified retail item.

In another exemplary embodiment, the method further includes each of the following: detecting a QR code on the target object based on the sequential image; and determining a retail item corresponding to the target object based on the QR code to obtain an identified retail item.

In another exemplary embodiment, the method further includes each of the following: sending, by the controller device, to an artificial intelligence (AI) circuitry. an indication that includes a request to predict, based on the sequential image, a retail item corresponding to the target object, wherein the AI circuitry is trained on information associated with a set of retail items; receiving, by the controller device, from the AI circuitry. an indication that includes at least one of the set of retail items and a corresponding confidence level; and selecting one of the at least one of the set of retail items based on the corresponding confidence level to obtain an identified retail item.

In another exemplary embodiment, the method further includes obtaining a price of the target object based on the identified retail item.

In another exemplary embodiment, the method further includes storing the identified retail item and the obtained price to a set of purchased items.

In another exemplary embodiment, the method further includes determining the at least one of a set of checkout statuses to associated with the target object to obtain a first checkout status of the target object.

In another exemplary embodiment, the method further includes obtaining the at least one of a set of visual indicators that corresponds to the first checkout status to obtain a first visual indicator of the target object.

In another exemplary embodiment, the method further includes determining the position of the target object in the field of view of the AR device based on the captured sequential image data and mapping the visual indicator proximate the position of the target object based on the position of the target object to obtain data that represents an augmented sequential image.

In another exemplary embodiment, a first checkout status of the set of checkout statuses indicates that the target object is unscanned and the corresponding visual indicator of the set of visual indicators includes a visual representation associated with an unscanned object.

In another exemplary embodiment, a second checkout status of the set of checkout statuses indicates that the target object is scanned and the corresponding visual indicator of the set of visual indicators includes a visual representation associated with a scanned object.

In another exemplary embodiment, a third checkout status of the set of checkout statuses indicates that the target object is to be weighed and the corresponding visual indicator of the set of visual indicators includes a visual representation associated with an object to be weighed.

In one exemplary embodiment, a controller device of a POS system is operationally coupled to an AR device. The AR device is configured to be worn and has an optical sensor with a field of view that corresponds to a field of view of the AR device and operable to capture a sequential image. The AR device also includes a display device configured to overlay a display of an augmented sequential image in the field of view of the AR device. The controller device further includes a processing circuitry and a memory, with the memory containing instructions executable by the processing circuitry whereby the processing circuitry is configured to send, by the controller device, to the AR device, an indication that includes data associated with an augmented sequential image that includes at least one of a set of visual indicators that indicates at least one of a set of checkout statuses of a target object disposed about the POS system. Further, the display device is operable to overlay the display of the augmented sequential image in the field of view of the AR device so that the at least one visual indicator of the set of visual indicators can be viewed proximate a position of the target object while the target object is viewable in the field of view of the AR device.

In another exemplary embodiment, the processing circuitry of the controller device is further configured to perform each of the following: receive, by the controller device, from the AR device, data that represents the sequential image captured by the optical sensor while the field of view of the optical sensor is directed towards the POS system with the sequential image having a set of objects disposed about the POS system; detect the set of objects disposed about the POS system based on the sequential image; and select one of the set of objects to obtain the target object.

In another exemplary embodiment, the processing circuitry of the controller device is further configured to classify or identify the target object based on the sequential image data and a set of retail items to obtain an identified retail item.

In another exemplary embodiment, the processing circuitry of the controller device is further configured to detect a QR code on the target object based on the sequential image data and determine a retail item corresponding to the target object based on the QR code to obtain an identified retail item.

In another exemplary embodiment, the processing circuitry of the controller device is further configured to perform each of the following: send to an artificial intelligence (AI) circuitry. an indication that includes a request to predict, based on the sequential image data, a retail item corresponding to the target object, wherein the AI circuitry is trained on information associated with a set of retail items; receive, by the controller device, from the AI circuitry. an indication that includes at least one of the set of retail items and a corresponding confidence level; and select one of the at least one of the set of retail items based on the corresponding confidence level to obtain an identified retail item.

In another exemplary embodiment, the processing circuitry of the controller device is further configured to obtain a price of the target object based on the identified retail item.

In another exemplary embodiment, the processing circuitry of the controller device is further configured to determine the at least one of a set of checkout statuses to associate with the target object to obtain a first checkout status of the target object.

In another exemplary embodiment, the processing circuitry of the controller device is further configured to obtain the at least one of a set of visual indicators that corresponds to the first checkout status of the target object to obtain a first visual indicator of the target object.

In another exemplary embodiment, the processing circuitry of the controller device is further configured to determine a position of the target object in the field of view of the AR device based on the sequential image data.

In another exemplary embodiment, the processing circuitry of the controller device is further configured to map the first visual indicator proximate the position of the target object based on the position of the target object to obtain data that represents an augmented sequential image.

In one exemplary embodiment, a POS system includes an AR device configured to be worn, having an optical sensor with a field of view that corresponds to a field of view of the AR device and operable to capture a sequential image, and having a display device configured to overlay a display of an augmented sequential image in the field of view of the AR device. The POS system also includes a controller device operationally coupled to the AR device and operable to send, by the controller device, to the AR device, an indication that includes at least one of a set of visual indicators that indicates at least one of a set of checkout statuses of a target object disposed about the POS system. Further, the display device is operable to overlay the display of the augmented sequential image in the field of view of the AR device so that the at least one visual indicator of the set of visual indicators can be viewed proximate a position of the target object while the target object is viewable in the field of view of the AR device.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein. Alternatively, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method, comprising:
by a controller device of a point of sale (POS) system that is operationally coupled to an augmented reality (AR) device, with the AR device being configured to be worn and having an optical sensor with a field of view that corresponds to a field of view of the AR device and operable to capture data that represents a sequential image and a display device configured to overlay a display of an augmented sequential image in the field of view of the AR device,
sending, by the controller device, to the AR device, an indication that includes data that represents an augmented sequential image that includes at least one of a set of visual indicators that indicates at least one of a set of checkout statuses of a target object disposed about the POS system, with the display device being operable to overlay the display of the augmented sequential image in the field of view of the AR device so that the at least one of the set of visual indicators can be viewed proximate a position of the target object while the target object is viewable in the field of view of the AR device.

2. The method of claim 1, further comprising:
receiving, by the controller device, from the AR device, the data that represents the sequential image captured by the optical sensor while the field of view of the optical sensor is directed towards the POS system with the sequential image having a set of objects disposed about the POS system;
detecting the set of objects disposed about the POS system based on the sequential image; and
selecting one of the set of detected objects to obtain the target object.

3. The method of claim 2, further comprising:
classifying or identifying the target object based on the sequential image data and a set of retail items to obtain an identified retail item.

4. The method of claim 3, further comprising:
obtaining a price of the target object based on the identified retail item.

5. The method of claim 2, further comprising:
determining the at least one of a set of checkout statuses to associate with the target object to obtain a first checkout status of the target object.

6. The method of claim 5, further comprising:
obtaining the at least one of a set of visual indicators that corresponds to the first checkout status of the target object to obtain a first visual indicator of the target object.

7. The method of claim 6, further comprising:
determining a position of the target object in the field of view of the AR device based on the sequential image data; and
mapping the first visual indicator proximate the position of the target object based on the position of the target object to obtain data that represents an augmented sequential image that includes the first visual indicator.

8. The method of claim 1, wherein a first checkout status of the set of checkout statuses indicates that the target object is unscanned and a corresponding visual indicator of the set of visual indicators includes a visual representation associated with an unscanned object.

9. The method of claim 1, wherein a second checkout status of the set of checkout statuses indicates that the target object is scanned and a corresponding visual indicator of the set of visual indicators includes a visual representation associated with a scanned object.

10. The method of claim 1, wherein a third checkout status of the set of checkout statuses indicates that the target object is to be weighed and a corresponding visual indicator of the set of visual indicators includes a visual representation associated with an object to be weighed.

11. A controller device, comprising:
with the controller device of a point of sale (POS) system being operationally coupled to an augmented reality (AR) device, with the AR device being configured to be worn, having an optical sensor with a field of view that corresponds to a field of view of the AR device and operable to capture data that represents a sequential image, and having a display device configured to overlay a display of an augmented sequential image in the field of view of the AR device; and
wherein the controller device further comprises a processing circuitry and a memory, with the memory containing instructions executable by the processing circuitry whereby the processing circuitry is configured to:
send, by the controller device, to the AR device, an indication that includes data that represents an augmented sequential image that includes at least one of a set of visual indicators that indicates at least one of a set of POS checkout statutes of a target object disposed about the POS system, with the display device being operable to overlay the display of the augmented sequential image in the field of view of the AR device so that the at least one of the set of visual indicators can be viewed proximate a position of the target object while the target object is viewable in the field of view of the AR device.

12. The controller device of claim 11, wherein the memory contains instructions executable by the processing circuitry whereby the processing circuitry is further configured to:
receive, by the controller device, from the AR device, the data that represents the sequential image captured by the optical sensor while the field of view of the optical sensor is directed towards the POS system with the sequential image having a set of objects disposed about the POS system;
detect the set of objects disposed about the POS system based on the sequential image; and
select one of the set of detected objects to obtain the target object.

13. The controller device of claim 12, wherein the memory contains instructions executable by the processing circuitry whereby the processing circuitry is further configured to:
classify or identify the target object based on the sequential image data and a set of retail items to obtain an identified retail item.

14. The controller device of claim 12, wherein the memory contains instructions executable by the processing circuitry whereby the processing circuitry is further configured to:
determine the at least one of a set of checkout statuses to associate with the target object to obtain a first checkout status of the target object.

15. The controller device of claim 14, wherein the memory contains instructions executable by the processing circuitry whereby the processing circuitry is further configured to:
obtain the at least one of a set of visual indicators that corresponds to the first checkout status of the target object to obtain a first visual indicator of the target object.

16. The controller device of claim 15, wherein the memory contains instructions executable by the processing circuitry whereby the processing circuitry is further configured to:
determine a position of the target object in the field of view of the AR device based on the sequential image data; and
map the first visual indicator proximate the position of the target object based on the position of the target object to obtain data that represents an augmented sequential image that includes the first visual indicator.

17. The controller device of claim 11, wherein a first checkout status of the set of checkout statuses indicates that the target object is unscanned and a corresponding visual indicator of the set of visual indicators associated with an unscanned object.

18. The controller device of claim 11, wherein a second checkout status of the set of checkout statuses indicates that the target object is scanned and a corresponding visual indicator of the set of visual indicators includes a visual representation associated with a scanned object.

19. The controller device of claim 11, wherein a third checkout status of the set of checkout statuses indicates that the target object is to be weighed and a corresponding visual indicator of the set of visual indicators includes a visual representation associated with an object to be weighed.

20. A point of sale (POS) system, comprising:
an augmented reality (AR) device configured to be worn, having an optical sensor with a field of view that corresponds to a field of view of the AR device and operable to capture data that represents a sequential image, and having a display device configured to overlay a display of an augmented sequential image that can be viewed in the field of view of the AR device; and
a controller device operationally coupled to the AR device and operable to:
send, by the controller device, to the AR device, an indication that includes at least one of a set of visual indicators that indicates at least one of a set of checkout statuses of a target object disposed about the POS system, with the display device being operable to overlay the display of the augmented sequential image in the field of view of the AR device so that the at least one of the set of visual indicators can be viewed proximate a position of the target object while the target object is viewable in the field of view of the AR device.
